(19) United States
(12) Patent Application Publication
(10) Pub. No.: US 2009/0025478 A1
(43) Pub. Date: Jan. 29, 2009

(54) Acceleration sensor

(75) Inventor: Shinsuke Miki, Miyazaki (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/153,500

(22) Filed: May 20, 2008

(30) Foreign Application Priority Data
Jul. 12, 2007 (JP) 2007-182966

(51) Int. Cl. G01P 15/12

(52) U.S. Cl. 73/514.33

(57) ABSTRACT

The present invention provides an acceleration sensor that improves endurance by avoiding damage to stopper portions. When a downward vibration is applied to a weight member and the weight member displaces downward, a bottom face of the weight member abuts a bottom plate, and the weight member stops and downward displacement is obstructed. Furthermore, when the weight member displaces upward, peripheral weight portions abut stopper portions, and the weight member stops and upward displacement is obstructed. Because displacement of the weight member is obstructed by abutting the stopper portions, if the strength of the stopper portions is low, the stopper portions may be damaged. However, by providing reinforcement portions which reinforce the stopper portions, damage to the stopper portions may be prevented, and endurance of the acceleration sensor is improved.

### CROSS-REFERENCE TO RELATED APPLICATION

This application claims priority under 35 USC 119 from Japanese Patent Application No. 2007-182966, the disclosure of which is incorporated by reference herein.

### BACKGROUND OF THE INVENTION

1. Field of the Invention

The present invention relates to an acceleration sensor for sensing acceleration in three axial directions X, Y and Z.

2. Description of the Related Art

According to an acceleration sensor described in Japanese Patent Application Laid-Open (JP-A) No. 2004-198243, when a vibration is propagated from an object of acceleration measurement and a weight member mounted at a weight fixing portion vibrates, the weight fixing portion displaces. As a result, beam portions adjoining the weight fixing portion flex, and resistance values of resistive elements attached to the beam portions change with the flexing of the beam portions. On the basis of this change in the resistance values, an acceleration of the acceleration measurement object is measured.

Displacement of the weight member downward is obstructed by a bottom face of the weight member abutting a floor plate. On the other hand, displacement of the weight member upward is obstructed by an upper face of the weight member abutting stopper portions.

Thus, because the stopper portions block upward displacement of the weight member, the acceleration sensor described in JP-A No. 2004-198243 avoids breakage of the resistive elements (acceleration sensor) by an excessive acceleration.

In recent years, improvements in endurance of acceleration sensors have been sought. In a previous acceleration sensor, if a stopper portion broke due to the weight member strongly abutting the stopper portion, the beam portions would flex greatly, and the resistive elements would be excessively displaced and broken.

### SUMMARY OF THE INVENTION

In consideration of the circumstances described above, the present invention is to improve endurance of an acceleration sensor by preventing breakages of stopper portions.

A first aspect of the present invention is an acceleration sensor including: a weight fixing portion; a weight member that includes a central weight portion which is fixed to the weight portion and a peripheral weight portion which is extended from the central weight portion; a peripheral fixing portion that is separated from a periphery of the weight fixing portion; a pedestal portion that supports the peripheral fixing portion; a beam portion that connects the weight fixing portion with the peripheral fixing portion; a stopper that is separated from the weight fixing portion, the weight member and the beam portion and that adjoins the peripheral fixing portion, wherein the stopper includes a stopper portion that comes into contact with the peripheral weight portion if the peripheral weight portion displaces upward excessively, and a reinforcement portion that extends from the stopper portion toward the beam portion.

According to the above-described first aspect of the present invention, the peripheral fixing portion of the substrate is supported at the pedestal portion. When a vibration is propagated to this pedestal portion, the weight member vibrates. Then, when the weight member vibrates, the weight fixing portion fixed to the central weight portion included in the weight member displaces. When the weight fixing portion displaces, the beam portion connected with the weight fixing portion flexes. If, for example, a resistive element is attached to the beam portion, a resistance value of the resistive element is changed by the flexing of the beam portion, and acceleration is detected on the basis of the change in the resistance value.

The stopper portion is provided at the stopper adjoining the peripheral fixing portion. The stopper portion comes into contact when a corner portion of the peripheral weight portion, which extends to four sides from the central weight portion, is displaced excessively. The stopper portion obstructs the displacement of the weight member by abutting the peripheral weight portion, and prevents breakage of the acceleration sensor by an excessive acceleration.

Now, it is thought that a stopper portion breaks when a peripheral weight portion strongly abuts against the stopper portion. However, the reinforcement portion, which extends from the stopper portion toward the beam portion, is provided at the stopper. This reinforcement portion ameliorates stress that is generated by the peripheral weight portion abutting the stopper portion. Accordingly, breakage of the stopper portion can be prevented. Hence, endurance of the acceleration sensor is improved.

In the above-described aspect, the reinforcement portion may include a linear edge.

According to the aspect described above, the reinforcement portion has a linear edge. Therefore, the linear edge flexes uniformly, and stress generated by the weight member abutting the stopper portion is ameliorated.

In the above-described aspect, the reinforcement portion may include a curved edge.

According to the aspect described above, the reinforcement portion has a curved edge. Therefore, the reinforcement portion does not locally change in shape, and prevents stress generated by the weight member abutting the stopper portion from concentrating locally.

According to the present invention, endurance of an acceleration sensor is improved by avoiding breakage of a stopper portion.

### BRIEF DESCRIPTION OF THE DRAWINGS

Exemplary embodiments of the present invention will be described in detail based on the following figures, wherein:

FIG. 1 is a magnified plan view showing an acceleration sensor relating to a first exemplary embodiment of the present invention;

FIG. 2A is a plan view showing the acceleration sensor relating to the first exemplary embodiment of the present invention;

FIG. 2B is a sectional view cut along line B-B of FIG. 2A showing the acceleration sensor relating to the first exemplary embodiment of the present invention;

FIG. 2C is a bottom view showing the acceleration sensor relating to the first exemplary embodiment of the present invention;

FIG. 2D is a sectional view cut along line D-D of FIG. 2A showing the acceleration sensor relating to the first exemplary embodiment of the present invention;

FIG. 3A to FIG. 3F are process views showing a fabrication process of the acceleration sensor relating to the first exemplary embodiment of the present invention;

FIG. 4A to FIG. 4E are process views showing the fabrication process of the acceleration sensor relating to the first exemplary embodiment of the present invention;

FIG. 5A to FIG. 5C are plan views showing patterns of respective layers of the acceleration sensor relating to the first exemplary embodiment of the present invention;

FIG. 6A is a perspective view showing results of analysis of the acceleration sensor relating to the first exemplary embodiment of the present invention;

FIG. 6B is a perspective view showing a comparative example to be compared with the results of analysis of the acceleration sensor relating to the first exemplary embodiment of the present invention;

FIG. 7A is a diagram showing results of analysis of the acceleration sensor relating to the first exemplary embodiment of the present invention, which represents in a graph a relationship between equivalent stress of a stopper portion (vertical axis) and time (horizontal axis);

FIG. 7B is a diagram showing results of analysis of the acceleration sensor relating to the first exemplary embodiment of the present invention, which represents in a graph a relationship between displacement of the stopper portion (vertical axis) and time (horizontal axis);

FIG. 8A is a diagram showing results of analysis of the acceleration sensor relating to the first exemplary embodiment of the present invention, which represents in a graph a relationship between equivalent stress of the stopper portion (vertical axis) and time (horizontal axis);

FIG. 8B is a diagram showing results of analysis of the acceleration sensor relating to the first exemplary embodiment of the present invention, which represents in a graph a relationship between displacement of the stopper portion (vertical axis) and time (horizontal axis);

FIG. 9A is a diagram showing results of analysis of the acceleration sensor relating to the first exemplary embodiment of the present invention, which represents a change in maximum equivalent stress of the stopper portion due to provision of a reinforcement portion;

FIG. 9B is a diagram showing results of analysis of the acceleration sensor relating to the first exemplary embodiment of the present invention, which represents a change in maximum equivalent stress of a beam portion due to provision of a reinforcement portion;

FIG. 10 is a diagram showing results of analysis of the acceleration sensor relating to the first exemplary embodiment of the present invention, which represents in a graph a relationship between equivalent stress of the beam portion (vertical axis) and time (horizontal axis); and

FIG. 11 is a magnified plan view showing an acceleration sensor relating to a second exemplary embodiment of the present invention.

### DETAILED DESCRIPTION OF THE INVENTION

### First Embodiment

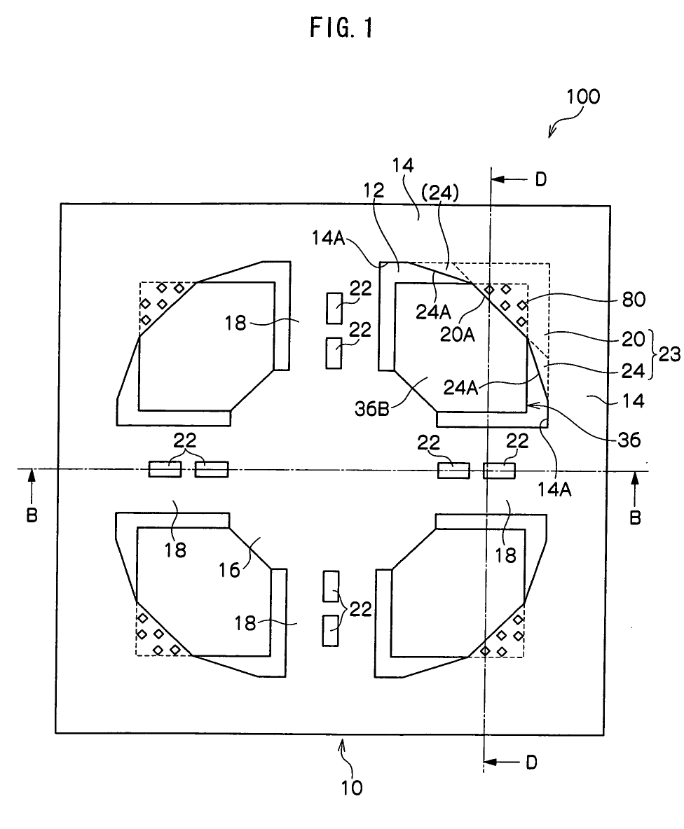

An acceleration sensor 100 relating to a first exemplary embodiment of the present invention will be described with reference to FIG. 1 to FIG. 10.

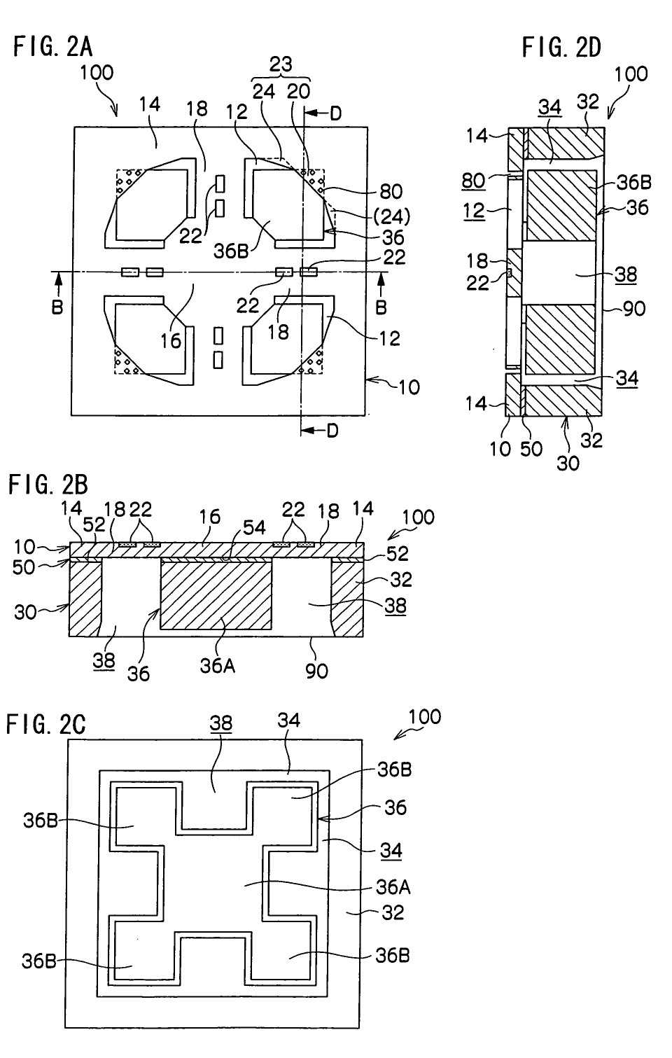

The acceleration sensor 100, as shown in FIG. 2B, is formed by etching and the like to an SOI (silicon on insulator) wafer, in which a first silicon substrate 10 with thickness about 5 μm and a second silicon substrate 30 with thickness about 525 μm are stuck together with an insulator layer 50 therebetween.

As shown in FIG. 1 and FIG. 2A, a single one of the silicon substrate 10 of the acceleration sensor 100 has a substantially square shape with sides of about 2.5 mm. Peripheral edge portions of the silicon substrate 10 are supported by pedestal portions 32, which will be described later (see FIG. 2B). Four opening portions 12 are provided at an inner side of the silicon substrate 10. Thus, respective regions of a peripheral fixing portion 14, a weight fixing portion 16, beam portions 18 and stoppers 23 are formed.

In detail, a weight member 36 is fixed to the weight fixing portion 16, which is provided at a central side of the silicon substrate 10 and each side of which is about 700 μm. The weight member 36 is provided with a central weight portion 36A (see FIG. 2C), with a cuboid shape corresponding with the weight fixing portion 16, and peripheral weight portions 36B, with cuboid shapes. The peripheral weight portions 36B are connected to four corners of the central weight portion 36A, are provided extending in four directions, and are in a state of non-contact with the silicon substrate 10.

As shown in FIG. 1, the silicon substrate 10 is opened up at the four sides of the weight fixing portion 16 and the opening portions 12 are provided. The opening portions 12 expose the peripheral weight portions 36B, leaving corner portions of the peripheral weight portions 36B covered.

The four beam portions 18, with width about 400 μm, are defined by the four opening portions 12 and provided so as to intersect in a longitudinal and lateral direction. The beam portions 18 are provided adjoining the weight fixing portion 16. Two rectangular resistive elements 22 are provided at the surface of each beam portion 18. The resistive elements 22 feature a piezoresistance effect in which electrical resistance changes with mechanical warping.

The peripheral fixing portion 14 is provided, in a square frame-form with a thickness of about 500 μm, adjoining the beam portions 18 at peripheral portions of the silicon substrate 10, and is joined to the pedestal portions 32 (see FIG. 2B).

Substantially triangular stopper portions 20, which come into contact with the corner portions of the peripheral weight portions 36B if the corner portions are displaced upward excessively, are provided at the stoppers 23. The stopper portions 20 are provided adjoining the peripheral fixing portion 14 at outer sides of the opening portions 12. Plural small opening portions 80 are formed in the stopper portions 20.

Reinforcement portions 24 are provided at each stopper 23, extending from the stopper portion 20 towards the beam portions 18. Opening edges 24A of the reinforcement portions 24, which face the opening portion 12, have linear forms.

As shown in FIG. 2D, the pedestal portions 32, with width about 500 μm, are provided in the silicon substrate 30 at peripheral sides corresponding with the peripheral fixing portion 14 of the silicon substrate 10. The pedestal portions 32 are disposed to provide gaps 34 between the pedestal portions 32 and the peripheral weight portions 36B. A bottom plate 90 is fixed to end portions of the pedestal portions 32, so as to sandwich the pedestal portions 32 between the bottom plate 90 and the silicon substrate 10.

As shown in FIG. 2B, at locations of the silicon substrate 30 corresponding to the beam portions 18 of the silicon substrate 10, silicon is removed to form trench portions 38. A thickness (i.e., height) of the weight member 36 is formed to be thinner than a thickness of the pedestal portions 32 by a maximum allowable displacement amount (for example, 5 μm).

The silicon substrates 10 and 30 are connected to one another, with an oxide film 52 of the insulator layer 50 and an oxide film 54 of the insulator layer 50 therebetween. The oxide film 52 is left to correspond with the peripheral fixing portion 14, and the oxide film 54 is left to correspond with the weight fixing portion 16.

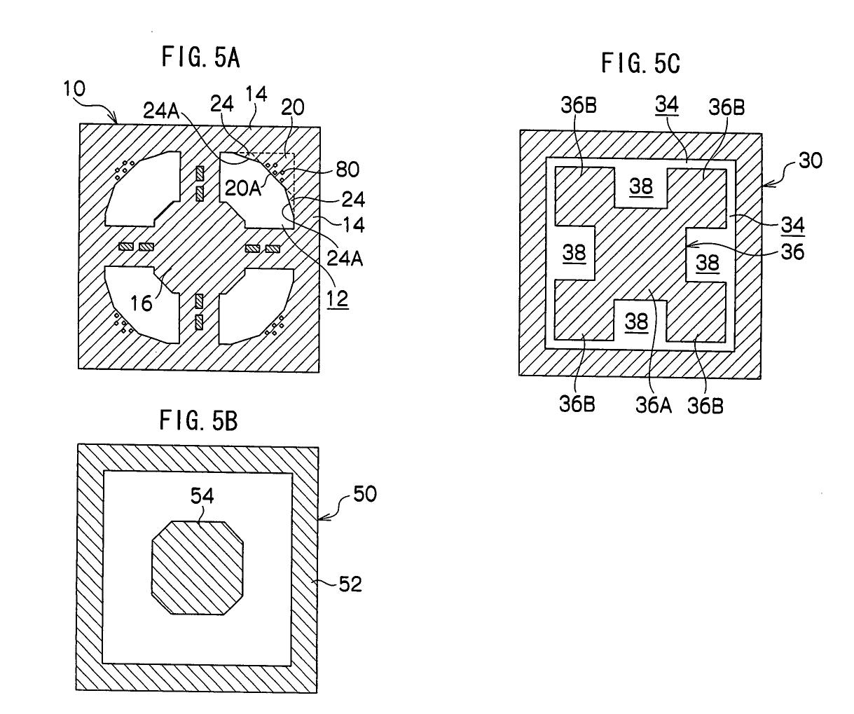

For reference, plan views showing patterns of the respective layers are illustrated in FIG. 5A to FIG. 5C. FIG. 5A is a plan view of the silicon substrate 10, FIG. 5B is a plan view of the insulator layer 50, and FIG. 5C is a plan view of the silicon substrate 30.

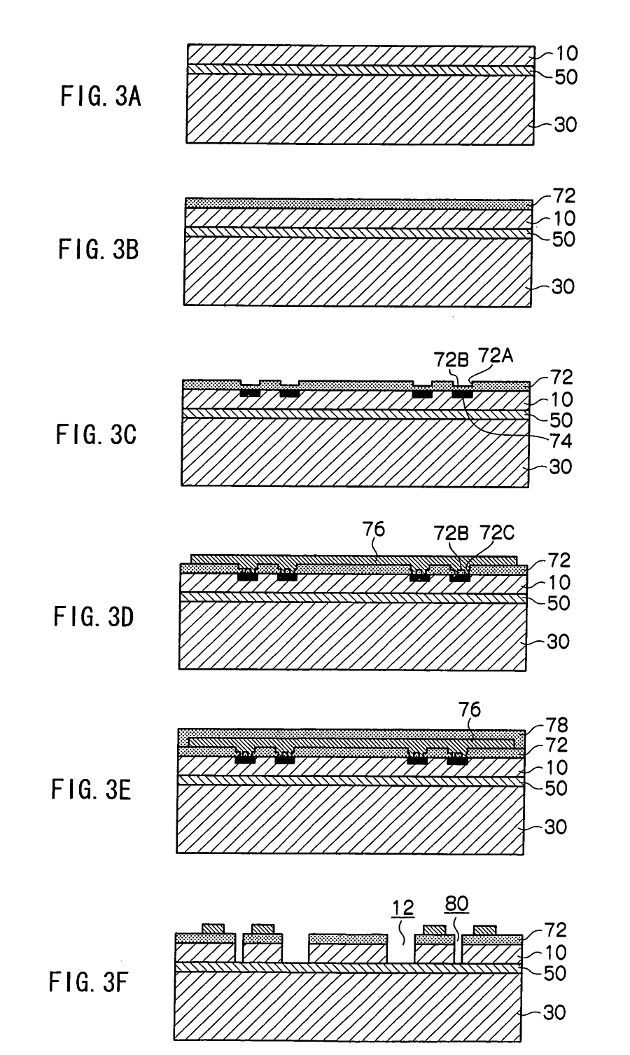

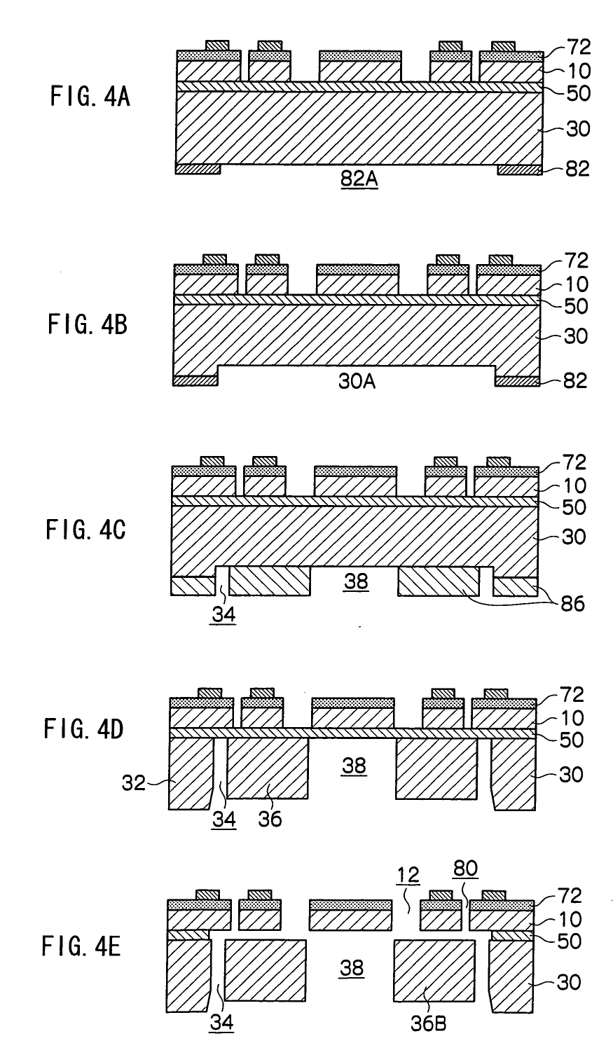

Next, a fabrication process of the acceleration sensor 100 will be described in accordance with FIG. 3A to FIG. 4E.

First, in step 1 as shown in FIG. 3A, an SOI wafer is prepared in which, for example, the silicon substrate 10, of N-type with thickness 5 μm and volume resistivity about 6 to 8 Ω/cm, and the silicon substrate 30, with thickness 525 μm and volume resistivity about 16 Ω/cm, are stuck together by the insulator layer 50, formed of silicon oxide with thickness about 5 μm.

Then, in step 2 as shown in FIG. 3B, a protective film 72, formed of silicon oxide with thickness about 0.4 μm, is formed at a surface of the silicon substrate 10, in thermal oxidization conditions using a humidified atmosphere at about 1,000° C.

Then, in step 3 as shown in FIG. 3C, opening portions 72A are formed in the protective film 72 using a photolithography etching technique. Then, a P-type diffusion layer 74, which will form the resistive elements 22 and the like (see FIG. 1), is formed at the surface of the silicon substrate 10 by a boron diffusion method. Further, a protective oxide film 72B is formed at a surface of the diffusion layer 74 by a CVD (chemical vapor deposition) method.

Then, in step 4 as shown in FIG. 3D, an electrode extraction aperture 72C is formed in the protective oxide film 72B using the photolithography etching technique. Then, aluminum is deposited on the protective film 72 using a metal sputtering technique. Further, the aluminum is etched using the photolithography etching technique, and wiring 76 is formed at this time.

Then, in step 5 as shown in FIG. 3E, a silicon nitride film 78 for protection is formed at surfaces of the protective film 72 and the wiring 76 formed thereon, using a PRD (plasma reactive deposition) method. From the descriptions of step 6 onward, the silicon nitride film 78 will not be shown in the related drawings.

Then, in step 6 as shown in FIG. 3F, a photoresist is formed on the silicon nitride film 78 and, using the photolithography etching technique, the opening portions 12, which set apart the beam portions 18 and the stopper portions 20, and the opening portions 80 (see FIG. 1) are formed. The opening portions 80 will be used for removing the insulator layer 50 that is interposed between the peripheral weight portions 36B and the stopper portions 20 in a later step.

Then, in step 7 as shown in FIG. 4A, an oxide film 82 is formed at a rear face of the SOI wafer, that is, a surface of the silicon substrate 30, using the CVD technique. A central portion of the oxide film 82 is removed using the photolithography etching technique, and an opening portion 82A is formed, leaving the oxide film 82 at the periphery so as to correspond with the pedestal portions 32.

Then, in step 8 as shown in FIG. 4B, using the oxide film 82 left at the peripheral portion as an etching mask, the surface of the silicon substrate 30 is etched by about 20 μm using a gas chopping etching technique (GCET, the “Bosch method”), and a recess portion 30A is formed.

Then, in step 9 as shown in FIG. 4C, an etching mask 86, for forming the gaps 34 and trench portions 38 between the pedestal portions 32 and weight member 36 in the silicon substrate 30, is formed by the photolithography technique.

Then, in step 10 as shown in FIG. 4D, the gaps 34 and trench portions 38 of the silicon substrate 30 are formed using GCET.

Then, in step 11 as shown in FIG. 4E, the SOI wafer for which the processing up to step 10 has been completed is immersed in buffering fluorinated acid, and the insulator layer 50 between the silicon substrates 10 and 30 is etched. At this time, the buffering fluorinated acid flows through the opening portions 12 and 80 provided in the silicon substrate 10 and the gaps 34 and trench portions 38 in the silicon substrate 30, and the insulator layer 50 interposed between the peripheral weight portions 36B and the stopper portions 20 is removed.

Thereafter, similarly to a usual semiconductor fabrication process, chips are cut from the SOI wafer, and predetermined wiring is implemented.

Next, operation of the acceleration sensor 100 will be described.

As shown in FIG. 2B, when acceleration is applied to the acceleration sensor 100, a stress acts on the weight member 36 due to inertial force, and the weight member 36 displaces. When the weight member 36 displaces, the weight fixing portion 16 which is joined to the central weight portion 36A included in the weight member 36 displaces. Further, when the weight fixing portion 16 displaces, the beam portions 18 adjoining the weight fixing portion 16 flex. Hence, resistance values of the resistive elements 22 attached to the beam portions 18 change, and the acceleration is detected on the basis of this change in the resistance values.

Now, when a downward vibration is applied to the weight member 36 and the weight member 36 displaces downward, a bottom face of the weight member 36 abuts the bottom plate 90. Therefore, the weight member 36 stops and the downward displacement is obstructed. When the weight member 36 displaces upward, the peripheral weight portions 36B abut the stopper portions 20 (see FIG. 1). Therefore, the weight member 36 stops and the upward displacement is obstructed.

In a case in which the weight member 36 displaces upward, the weight member 36 abuts against the stopper portions 20 and the displacement is obstructed. Accordingly, if strength of the stopper portions 20 were low, the stopper portions 20 would break. Further, if the stopper portions 20 were to break, the beam portions 18 would flex greatly and the resistive elements 22 would displace excessively and break. However, in the present exemplary embodiment, the reinforcement portions 24 which reinforce each stopper portion 20 are provided at both sides of the stopper portion 20.

Structural analysis was performed to confirm the operation of the reinforcement portions 24. The results thereof are described below.

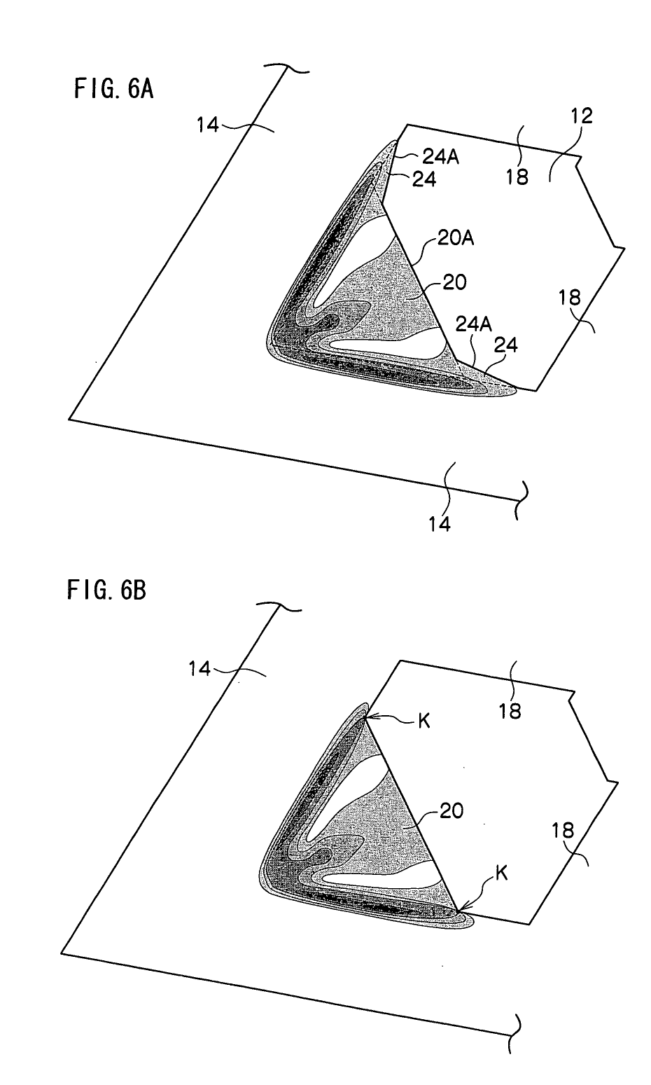

FIG. 6A shows stress when the peripheral weight portion 36B (see FIG. 1) displacing upward abuts against the stopper portion 20. The dark hue portions are a region of high stress, and the light hue portions are a region of low stress. FIG. 6B shows a case in which the reinforcement portions 24 are not provided at the stopper portion 20, which is a comparative example with FIG. 6A.

From FIG. 6A and FIG. 6B, it is seen that the stress concentrates along two intersecting sides of the triangular stopper portion 20. As is shown in FIG. 6B, with the previous structure in which the reinforcement portions 24 are not provided, the stress concentration region with the darkened hue extends to a point K at which an edge portion of the stopper portion 20 and an edge portion of the peripheral fixing portion 14 intersect. Therefore, with the previous structure, it is possible that cracks will occur with this point K being a point of origin. However, as shown in FIG. 6A, when the reinforcement portions 24 are provided, the stress concentration region is kept within the face of the reinforcement portion 24 and does not reach as far as the edge portions. Thus, occurrences of cracking from the edge portions are effectively prevented.

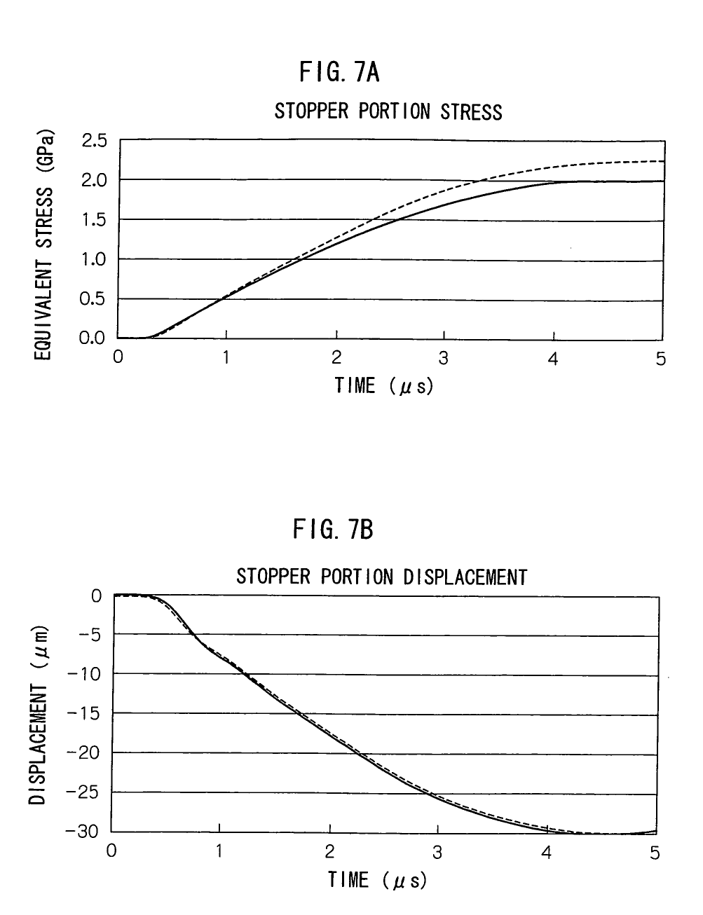

FIG. 7A shows, in a graph, a relationship between equivalent stress of the stopper portion 20 (vertical axis) and time (horizontal axis) when the peripheral weight portion 36B displacing upward abuts against the stopper portion 20. The broken line shows the relationship between equivalent stress and time in the case in which the reinforcement portions 24 are not provided, while the solid line shows the relationship between equivalent stress and time with the structure of the present exemplary embodiment in which the reinforcement portions 24 are provided. As is seen by comparing the broken line and the solid line, the equivalent stress of the stopper portion 20 can be reduced by the provision of the reinforcement portions 24.

FIG. 7B shows, in a graph, a relationship between displacement of the stopper portion 20 (vertical axis) and time (horizontal axis) when the weight member 36 displacing upward abuts against the stopper portion 20. The broken line shows the relationship between displacement and time with the structure in which the reinforcement portions are not provided, while the solid line shows the relationship between displacement and time with the structure of the present exemplary embodiment in which the reinforcement portions 24 are provided. As is seen by comparing the broken line and the solid line, there is hardly any change at all in displacement of the stopper portion 20 with presence or absence of the reinforcement portions 24.

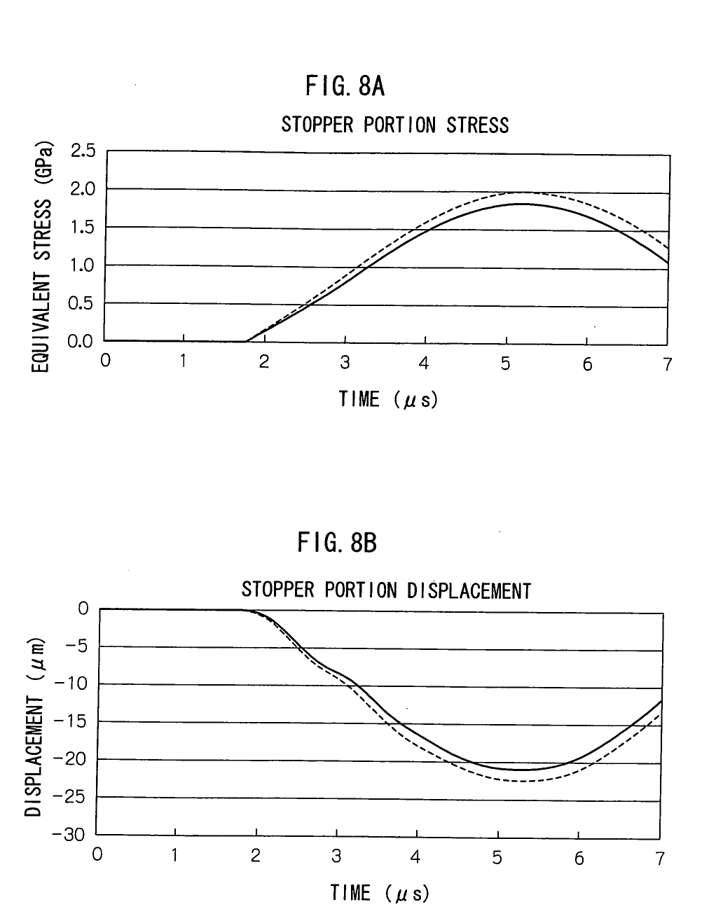

FIG. 8A shows, in a graph, a relationship between equivalent stress of the stopper portion 20 (vertical axis) and time (horizontal axis) when the peripheral weight portion 36B displacing in a left-right direction abuts against the stopper portion 20. The broken line shows the relationship between stress and time with the structure in which the reinforcement portions 24 are not provided, while the solid line shows the relationship between stress and time with the structure of the present exemplary embodiment in which the reinforcement portions 24 are provided. As is seen by comparing the broken line and the solid line, the equivalent stress of the stopper portion 20 can be reduced by the provision of the reinforcement portions 24.

FIG. 8B shows, in a graph, a relationship between displacement of the stopper portion 20 (vertical axis) and time (horizontal axis) when the weight member 36 displacing to left/right abuts against the stopper portion 20. The broken line shows the relationship between displacement and time with the structure in which the reinforcement portions are not provided, while the solid line shows the relationship between displacement and time with the structure of the present exemplary embodiment in which the reinforcement portions 24 are provided. As is seen by comparing the broken line and the solid line, displacement of the stopper portion 20 can be made smaller by the provision of the reinforcement portions 24.

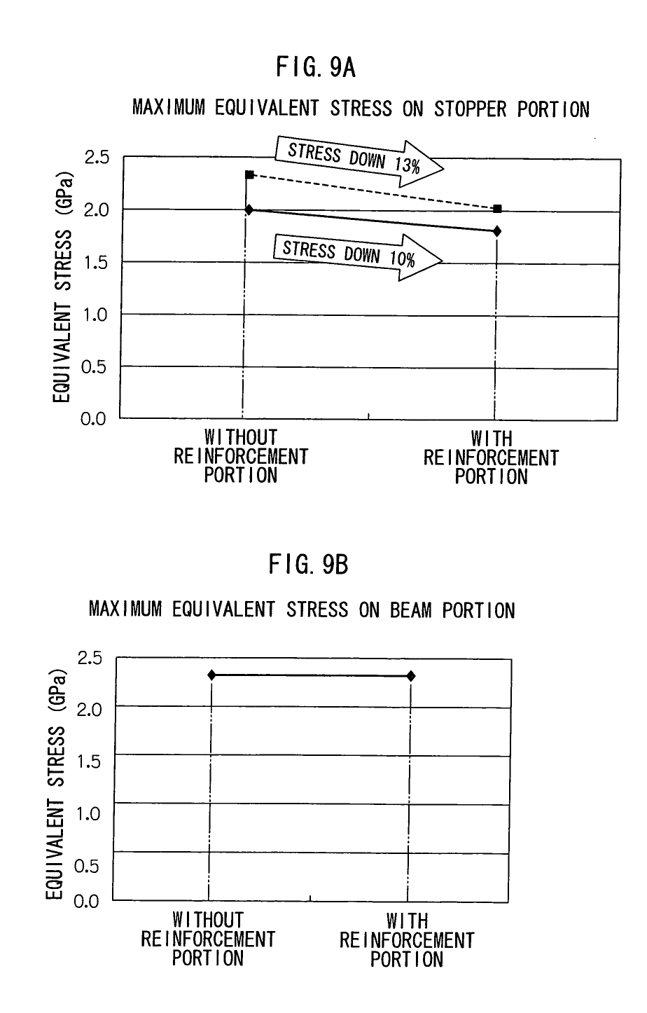

FIG. 9A shows a change in maximum equivalent stress of the stopper portion 20 due to the provision of the reinforcement portions 24. The broken line shows a change in maximum equivalent stress for the weight member 36 displacing upward and abutting the stopper portion 20, while the solid line shows a change in maximum equivalent stress for the weight member 36 displacing to left/right and abutting the stopper portion 20. For the weight member 36 displacing upward, the maximum equivalent stress is decreased by 13% by the provision of the reinforcement portions 24. For the weight member 36 displacing to left/right, the maximum equivalent stress is decreased by 10% by the provision of the reinforcement portions 24.

FIG. 9B shows how equivalent stress of the beam portion 18, when the weight member 36 displacing to left/right abuts against the stopper portion 20, is changed by the provision of the reinforcement portions 24. It is seen that the equivalent stress of the beam portion 18 does not change with the presence or absence of the reinforcement portions 24.

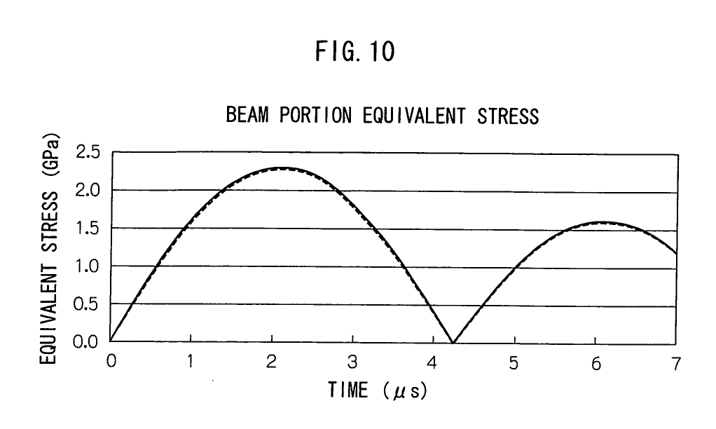

FIG. 10 shows, in a graph, a relationship between equivalent stress of the beam portion 18 (vertical axis) and time (horizontal axis) when the weight member 36 displacing in the left-right direction abuts against the stopper portion 20. The broken line shows the relationship between equivalent stress and time with the structure in which the reinforcement portions 24 are not provided, while the solid line shows the relationship between equivalent stress and time with the structure of the present exemplary embodiment in which the reinforcement portions 24 are provided. As is seen by comparing the broken line and the solid line, there is hardly any change with presence or absence of the reinforcement portions 24. That is, it is seen that the equivalent stress of the beam portion 18 is not altered by the provision of the reinforcement portions 24 but the equivalent stress of the stopper portion 20 falls.

As is seen from the analysis results above, when the reinforcement portions 24 are provided at both sides of the stopper portions 20, stresses of the stopper portions 20 fall, and breakages of the stopper portions 20 can be avoided. Hence, endurance of the acceleration sensor 100 is improved.

Moreover, because the opening edges 24A of the reinforcement portions 24, which face the opening portions 12, are in linear forms, linear portions flex equally. As a result, stresses that are generated by the peripheral weight portions 36B abutting the stopper portions 20 are ameliorated.

Furthermore, the four beam portions 18 are delineated by the opening portions 12, and the beam portions 18 flex easily. Therefore, sensitivity of the acceleration sensor 100 is improved.

### Second Embodiment

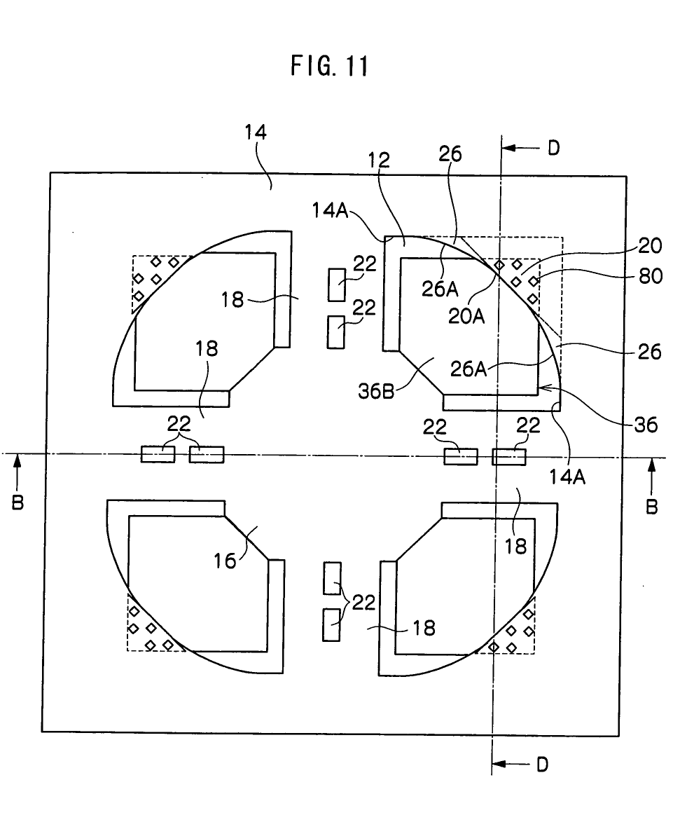

Next, a second exemplary embodiment of the acceleration sensor 100 of the present invention will be described in accordance with FIG. 11.

Here, members the same as in the first exemplary embodiment are assigned the same reference numerals and will not be described.

As shown in FIG. 11, differently from the first exemplary embodiment, opening edges 26A of reinforcement portions 26, which face the opening portions 12, have curved forms, and are provided so as to join with opening edges 20A of the stopper portions 20 and opening edges 14A of the peripheral fixing portion 14.

Consequently, localized changes of shape will not occur at the opening edges 14A, the opening edges 20A and the opening edges 26A. Therefore, localized concentrations of stresses caused by the peripheral weight portions 36B abutting the stopper portions 20 can be prevented.

What is claimed is:

1. An acceleration sensor comprising:
a weight fixing portion;
a weight member that includes a central weight portion which is fixed to the weight portion and a peripheral weight portion which is extended from the central weight portion;
a peripheral fixing portion that is separated from a periphery of the weight fixing portion;
a pedestal portion that supports the peripheral fixing portion;
a beam portion that connects the weight fixing portion with the peripheral fixing portion;
a stopper that is separated from the weight fixing portion, the weight member and the beam portion and that adjoins the peripheral fixing portion, wherein the stopper includes a stopper portion that comes into contact with the peripheral weight portion if the peripheral weight portion displaces upward excessively, and a reinforcement portion that extends from the stopper portion toward the beam portion.

2. The acceleration sensor of claim 1, wherein the reinforcement portion includes a linear edge.

3. The acceleration sensor of claim 1, wherein the reinforcement portion includes a curved edge.

4. An acceleration sensor comprising:
a substrate that includes a weight fixing portion, a peripheral fixing portion that is separated from a periphery of the weight fixing portion, a beam portion that connects the weight fixing portion with the peripheral fixing portion, a stopper that is separated from the weight fixing portion and the beam portion and that adjoins the peripheral fixing portion, and an opening portion that defines the weight fixing portion, the peripheral fixing portion, the beam portion and the stopper;
a pedestal portion that supports the peripheral fixing portion; and
a weight member that includes a central weight portion that is fixed to the weight fixing portion and a peripheral weight portion extending in four directions from the central weight portion,
wherein the stopper includes a stopper portion that comes into contact with a corner portion of the peripheral weight portion if the corner portion displaces upward excessively, and a reinforcement portion that extends from the stopper portion toward the beam portion.

5. An acceleration sensor comprising:
a weight fixing portion;
a peripheral fixing portion that is separated from a periphery of the weight fixing portion;
a beam portion that connects the weight fixing portion with the peripheral fixing portion;
a stopper that is separated from the weight fixing portion and the beam portion and that adjoins the peripheral fixing portion, and that includes a stopper portion and a reinforcement portion;
an opening portion that defines the weight fixing portion, the peripheral fixing portion, the beam portion and the stopper;
a substrate that includes the weight fixing portion, the peripheral fixing portion, the beam portion, the stopper and the opening portion;
a pedestal portion that supports the peripheral fixing portion;
a central weight portion that is fixed to the weight fixing portion;
a peripheral weight portion extending in four directions from the central weight portion; and
a weight member that includes the central weight portion and the peripheral weight portion,
wherein, if a corner portion of the peripheral weight portion displaces upward excessively, the stopper portion comes into contact therewith, and wherein the reinforcement portion extends from the stopper portion toward the beam portion.

6. The acceleration sensor of claim 5, wherein the reinforcement portion includes a linear edge.

7. The acceleration sensor of claim 5, wherein the reinforcement portion includes a curved edge.
